(19) United States
(12) Patent Application Publication
(10) Pub. No.: US 2023/0104220 A1
(43) Pub. Date: Apr. 6, 2023

(54) RADIO RESOURCE ALLOCATION

(71) Applicant: Telefonaktiebolaget LM Ericsson (publ), Stockholm (SE)

(72) Inventors: David Sandberg, Sundbyberg (SE); Tor Kvernvik, Täby (SE); Hjalmar Olsson, Bromma (SE)

(21) Appl. No.: 17/911,446

(22) PCT Filed: Mar. 17, 2020
(86) PCT No.: PCT/SE2020/050277

§ 371 Date: Sep. 14, 2022

(51) Int. Cl. H04W 72/12; H04W 28/16; H04L 41/16

(52) U.S. Cl. CPC H04W 72/1205; H04L 41/16; H04W 28/16

(57) ABSTRACT

A method for managing allocation of radio resources to users in a cell of a communication network during an allocation episode is disclosed. The method comprises generating a representation of a scheduling state of the cell for the allocation episode and generating a radio resource allocation decision for the allocation episode by performing a series of steps sequentially for each radio resource or for each user in the representation. The steps comprise selecting a radio resource or a user and using a trained neural network to update a partial radio resource allocation decision for the allocation episode on the basis of a current version of the scheduling state representation and updating the scheduling state representation to include the updated partial radio resource allocation decision. The method further comprises initiating allocation of cell radio resources to users during the allocation episode in accordance with the generated radio resource allocation decision.

### TECHNICAL FIELD

The present disclosure relates to methods for managing allocation of radio resources to users in a cell of a communication network, and for training a neural network for selecting a radio resource allocation for a radio resource or user. The present disclosure also relates to a scheduling node, a training agent and to a computer program and a computer program product configured, when run on a computer to carry out methods performed by a scheduling node and training agent.

### BACKGROUND

One of the roles of the base station in a cellular communication network is to allocate radio resources to users. Radio resource allocation is performed once per Transmission Time Interval (TTI). In the Radio Access Network (RAN) of 4^{th} Generation (LTE) communication networks, and of 5^{th} Generation (5G) communication networks, also referred to as new Radio (NR), the TTI duration is of 1 ms or less. The precise TTI duration depends on the sub-carrier spacing and on whether or not mini-slot scheduling is used.

A base station may make use of a range of information when allocating resources to users. Such information may include information about the latency and throughput requirements for each user and traffic type, a user’s instantaneous channel quality (including potential interference from other users) etc. Different users are typically allocated to different frequency resources, referred to in NR as Physical Resource Blocks (PRB), but can also be allocated to overlapping frequency resources in case of Multi-User MIMO (MU-MIMO). A scheduling decision is sent to the relevant User Equipment (UE) in a message called Downlink Control Information (DCI) on the Physical Downlink Control Channel (PDCCH).

Frequency selective scheduling is a way to use variations in channel frequency impulse response. A base station, referred to in 5G as a gNB, maintains an estimate of the channel response for users in the cell, and tries to allocate users to frequencies in order to optimize some objective (such as sum throughput). In order to perform this frequency selective scheduling, most existing scheduling algorithms resort to some kind of heuristics.

FIG. 1 illustrates an example in which two users with different channel quality are scheduled using frequency selective scheduling. In the example of FIG. 1, of the two UEs present, only one UE is scheduled for each Physical Resource Block (PRB). The state of the UE is represented by the amount of data in the Radio Link Control (RLC) buffer and the Signal-to-Interference-plus-Noise Ratio (SINR) per PRB. In the first 3 resource blocks, labelled A, it is most favorable to schedule UE1 (dashed line), and in the next four blocks, labelled B, it is more favorable to schedule UE2 (dotted line). This simple scheduling problem can be handled with a simple mechanism, such as, for each PRB, to schedule the UE with the highest potential SINR gain compared to the UEs mean SINR to that PRB.

Multi-User Multiple-In-Multiple-Out (MU-MIMO) Scheduling involves a Base station assigning multiple users to the same time/frequency resource. This introduces an increased amount of interference between the users, and so reduced SINR. The reduced SINR leads to reduced throughput and some of the potential gains with MU-MIMO may be lost.

Coordinated Multi-Point (CoMP) Transmission is a set of techniques according to which processing is performed over a set of transmission points (TPs) rather than for each TP individually. This can improve performance in scenarios where the cell overlap is large and interference between TPs can become a problem. In these scenarios it can be advantageous to let a scheduler make decisions for a group of TPs rather than using uncoordinated schedulers for each TP. For example, a UE residing on the border between two TPs could be selected for scheduling in any of the two TPs or in both TPs simultaneously.

Resource allocation problems can be very time consuming to solve optimally, for example using exhaustive search, and practical solutions therefore often resort to different types of heuristics such as that described above for frequency selective scheduling. These heuristics can be made to work very well in most cases, but there are specific scenarios for which good heuristics are more difficult to design. In addition, when users have a limited amount of data in their buffers, scheduling algorithms can easily get stuck in local optima, failing to find a global optimum solution. For some scheduling problems there are also additional constraints. For example, when using Discrete Fourier Transform (DFT) precoded Orthogonal Frequency-Division Multiplexing (OFDM), the allocated PRBs for a user are required to be continuous, which adds another constraint to the resource allocation algorithm.

The problem of resource allocation becomes even more complex if Multi-User MIMO is used. In this case, the scheduling algorithm has the freedom to assign multiple users to the same PRB. However, when the channels for two users are very similar, the penalty in terms of reduced SINR may be too large, and the resulting sum throughput can be lower than if the two users where scheduled on different PRBs. This problem is often solved by first finding users with channels that are sufficiently different and only allowing such users to be co-scheduled (i.e. scheduled on the same PRB). This approach however does not take other restrictions, like the amount of data in the buffers, into account, and the resulting scheduling decision can therefore be suboptimal.

US 2019/0124667 proposes using reinforcement learning techniques to achieve optimal allocation of transmission resources on the basis of Quality of Service (QoS) parameters for individual traffic flows. US 2019/0124667 discloses a complex procedure in which a Look Up Table (LUT) is used to map a state to two planners, CT(time) and CF(Frequency), which then map to a resource allocation plan. The LUT is trained via reinforcement learning.

### SUMMARY

It is an aim of the present disclosure to provide a scheduling node, training agent and computer readable medium which at least partially address one or more of the challenges discussed above. It is a further aim of the present disclosure to provide a scheduling node, training agent and computer readable medium which cooperate to facilitate selection of optimal or close to optimal scheduling decisions without relying on pre-programmed heuristics.

According to a first aspect of the present disclosure, there is provided a computer implemented method for managing allocation of radio resources to users in a cell of a communication network during an allocation episode. The method comprises generating a representation of a scheduling state of the cell for the allocation episode, wherein the scheduling state representation includes radio resources of the cell that are available for allocation during the allocation episode, users requesting allocation of cell radio resources during the allocation episode, and a current allocation of cell radio resources to users for the allocation episode. The method further comprises generating a radio resource allocation decision for the allocation episode by performing a series of steps sequentially for each radio resource or for each user in the representation. The steps comprise selecting, from the radio resources and users in the representation, a radio resource or a user, and using a trained neural network to update a partial radio resource allocation decision for the allocation episode on the basis of a current version of the scheduling state representation, such that the partial radio resource allocation decision comprises an allocation for the selected radio resource or user. The steps further comprise updating the scheduling state representation to include the updated partial radio resource allocation decision. The method further comprises initiating allocation of cell radio resources to users during the allocation episode in accordance with the generated radio resource allocation decision.

According to another aspect of the present invention, there is provided a computer implemented method for training a neural network having a plurality of parameters, wherein the neural network is for selecting a radio resource allocation for a radio resource or user in a communication network. The method comprises generating a representation of a scheduling state of a simulated cell of the communication network for an allocation episode, wherein the scheduling state representation includes radio resources of the simulated cell that are available for allocation during the allocation episode, users requesting allocation of simulated cell radio resources during the allocation episode, and a current allocation of simulated cell radio resources to users for the allocation episode. The method further comprises performing a series of steps sequentially for each radio resource or for each user in the representation. The steps comprise selecting from the radio resources and users in the scheduling state representation, a radio resource or a user, and performing a look ahead search of possible future scheduling states of the simulated cell according to possible radio resource allocations for the selected radio resource or user, wherein the look ahead search is guided by the neural network in accordance with current values of the neural network parameters and a current version of the scheduling state representation, and wherein the look ahead search outputs a search allocation prediction and a search success prediction. The steps further comprise adding the current version of the scheduling state representation, and the search allocation prediction and search success prediction output by the look ahead search, to a training data set, selecting a resource allocation for the selected radio resource or user in accordance with the search allocation prediction output by the look ahead search, and updating the current scheduling state representation of the simulated cell to include the selected radio resource allocation for the selected radio resource or user. The method further comprises using the training data set to update the values of the neural network parameters. The parameters the values of which are updated may comprise trainable parameters of the neural network, including weights.

According to another aspect of the present disclosure, there is provided a computer program and a computer program product configured, when run on a computer to carry out methods as set out above.

According to another aspect of the present disclosure, there is provided a scheduling node and training agent, each of the scheduling node and training agent comprising processing circuitry configured to cause the scheduling node and training agent respectively to carry out methods as set out above.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates an example scheduling problem in which two users with different channel quality are scheduled using frequency selective scheduling;

FIG. 2 illustrates phases of the AlphaZero game play algorithm;

FIG. 3 illustrates self-play using Monte-Carlo Tree Search;

FIG. 4 illustrates use of a Neural Network during self-play;

FIG. 5 illustrates a simple scheduling example;

FIG. 6 is a flow chart illustrating process steps in a method for managing allocation of radio resources to users in a cell of a communication network;

FIG. 7 illustrates features that may be included within a representation of a scheduling state;

FIG. 8 illustrates how a trained neural network may be used to update a partial radio resource allocation decision;

FIG. 9 is a flow chart illustrating process steps in a method 900 for training a neural network;

FIG. 10 illustrates process steps in a look ahead search;

FIG. 11 illustrates use of multiple simulated cells to generate training data;

FIG. 12 illustrates a neural network architecture;

FIG. 13 illustrates a state tree representing two PRBs and two users;

FIG. 14 is a flow chart illustrating MCTS according to an example of the present disclosure;

FIG. 15 is a flow chart illustrating training of a neural network;

FIG. 16 illustrates a training loop in the form of a flow chart;

FIG. 17 shows an overview of online resource allocation;

FIG. 18 illustrates live scheduling in the form of a flow chart;

FIG. 19 illustrates optimal PRB allocation for an example scheduling problem;

FIG. 20 shows results of concept testing;

FIG. 21 illustrates functional modules in a scheduling node;

FIG. 22 illustrates functional modules in another example of scheduling node;

FIG. 23 illustrates functional modules in a training agent;

FIG. 24 illustrates functional modules in another example of training agent;

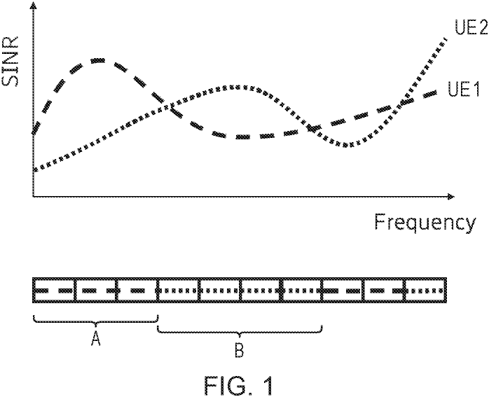

### DETAILED DESCRIPTION

Aspects of the present disclosure propose to approach the task of scheduling resources in a communication network as a problem of sequential decision making, and to apply methods that are tailored to such sequential decision making problems in order to find optimal or near optimal scheduling decisions. Examples of the present disclosure propose to use a combination of look ahead search, such as Monte Carlo Tree Search (MCTS), and Reinforcement Learning to train a sequential scheduling policy which is implemented by a neural network during online execution. During training, which may be performed off-line in a simulated environment, the neural network is used to guide the look ahead search. The trained neural network policy may then be used in a base station in a live network to allocate radio resources to users during a TTI.

An algorithm combining MCTS and reinforcement learning for game play has been proposed by DeepMind Technologies Limited in the paper ‘Mastering Chess and Shogi by Self-Play with a general Reinforcement Learning Algorithm’ (https://arxiv.org/abs/1712.01815). The algorithm, named AlphaZero, is a general algorithm for solving any game with perfect information i.e. the game state is fully known to both players at all times. No prior knowledge except the rules of the game is needed. In order to provide additional context to the methods for allocation of radio resources and training a neural network disclosed herein, there now follows a brief outline of the main concepts of AlphaZero.

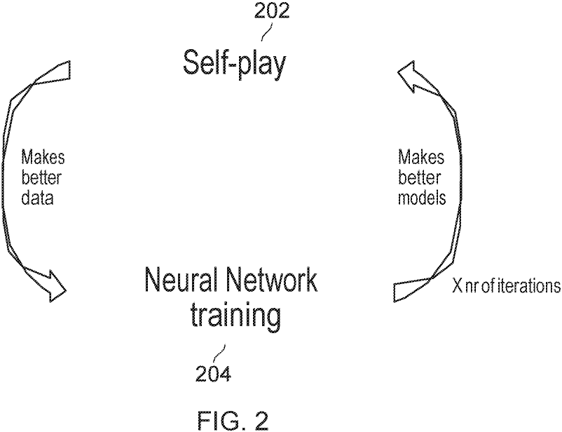

FIG. 2 illustrates the two main phases of AlphaZero: self-play 202 and Neural Network training 204. During self-play 202, AlphaZero plays against itself, with each side choosing moves selected by MCTS, the MCTS guided by a neural network model which is used to predict a policy and value. The results of self-play games are used to continually improve the neural network model during training 204. The self-play and neural network training occur in a sequence, each improving the other, with the process performed for a number of iterations until the neural network is fully trained. The quality of the neural network can be measured by monitoring the loss of the value and policy prediction, as discussed in further detail below.

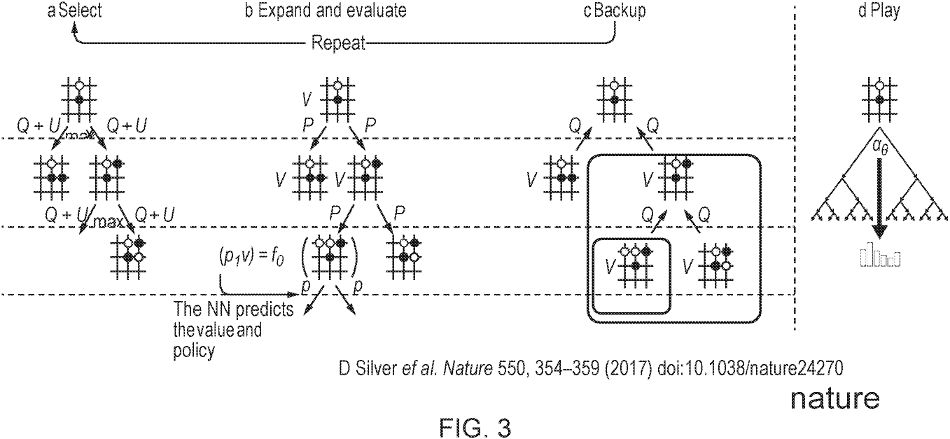

FIG. 3 illustrates self-play using Monte-Carlo Tree Search, and is reproduced from D Silver et al. Nature 550, 354-359 (2017) doi: 10.1038/Nature24270. In the tree search, each node of the tree represents a game state, with valid moves in the game transitioning the game from one state to the next. The root node of the tree is the current game state, with each node of the tree representing a possible future game state, according to different game moves. Referring to FIG. 3, self-play using MCTS comprises the following steps:
a) Select: Starting at the root node, walk to the child node with maximum Polynomial Upper Confidence Bound for Trees (PUCT i.e. max Q+U as discussed below) until a leaf node is found.
b) Expand and Evaluate: Expand the leaf node and evaluate the associated game state s using the neural network. Store the vector of probability values P in the outgoing edges from s.
c) Backup: Update the Action value Q for actions to track the mean of all evaluations V in the subtree below that action. The Q-value is propagated up to all states that led to a state
d) Play: Once the search is complete, return search probabilities Π that are proportional to N, where N is the visit count of each move from the root state. Select the move having the highest search probability.

During a Monte-Carlo Tree Search (MCTS) simulation, the algorithm evaluates potential next moves based on both their expected game result, and how much it has already explored them. This is the Polynomial Upper Confidence Bound for Trees, or Max Q+U which is used to walk from the root node to a leaf node. A constant c_{puct} is used to control the trade-off between expended game result and exploration:
PUCT(s, a) = Q(s, a) + U(s, a), where U is calculated as follows:
$$U \left(s , a\right) = {c}_{\text{puct}} P \left(s , a\right) \frac{\sqrt{{\sum }_{b} N \left(s , b\right)}}{1 + N \left(s , a\right)}$$
Q is the mean action value. This is the average game result across current simulations that took action a.
P is the prior probabilities as fetched from the Neural Network.
N is the visit count, or number of times the algorithm has taken this action during current simulations
N(s,a) is the number of times an action (a) has been taken from state (s)
∑_{b}^{N(s,b)} is the total number of times state (s) has been visited during the search

The neural network is used to predict the value for each move, i.e. who’s ahead and how likely it is to win the game from this position, and the policy, i.e. a probability vector for which move is preferred from the current position (with the aim of winning the game). After a certain number of self-plays the collected tuples state, policy, final game result (s, pi, z) generated by the MCTS are used to train the neural network. The loss function that is used to train the neural network is the sum of the:
Difference between the move probability vector (policy output) generated by the neural network and the moves explored by the Monte-Carlo Tree Search.
Difference between the estimated value of a state (value output) and who actually won the game.
A regularization term

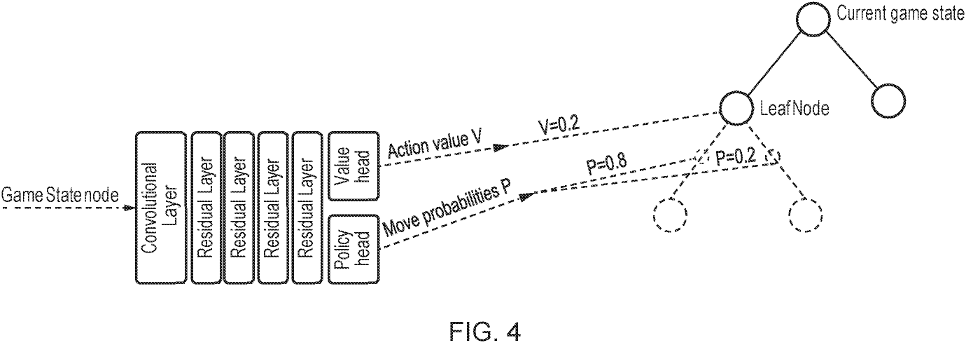

FIG. 4 illustrates an example how the neural network is used during self-play. The game state is input to the neural network which predicts both the value of the state (Action value V) and the probabilities of taking the actions from that state (probabilities vector P). The outputs of the neural network are used to guide the MCTS in order to generate the MCTS output probabilities pi, which are used to select the next move in the game.

The AlphaZero algorithm described above is an example of a game play algorithm, designed to select moves in a game, one move after another, adapting to the evolution of the game state as each player implements their selected moves and so changes the overall state of the game. Examples of the present disclosure are able to exploit methods that are tailored to such sequential decision making problems by reframing the problem of resource allocation for a scheduling interval, such as a TTI, as a sequential problem. For the purposes of the present disclosure, “sequential” in this context refers to an approach of “one by one”, without implying any particular order or hierarchy between the elements that are considered “one by one”. This is a departure from existing methods, which view the process of deciding which resources to schedule to which users as a single challenge, mapping information about users and radio resources during a scheduling interval directly to a scheduling plan for that interval. The reframing of resource selection for scheduling as a sequential decision making problem is discussed in greater detail below.

According to examples of the present disclosure, a TTI is treated as a single scheduling interval, and resource allocation is performed for each TTI. The TTI may be for example ⅟n ms, where n=1 in LTE and n={1, 2, 4, 8} in NR. The number of PRBs to be scheduled for each TTI may for example be 50, and the number of users may be between 0 and 10 in a realistic scenario. There is no specific order between the PRBs that should be scheduled for each TTI. For Multi-user MIMO the number of possible combinations of users and resources grows exponentially, and for any practical solution it is not possible to perform an exhaustive search to check all possible combinations in order to identify an optimal combination.

Example methods proposed in the present disclosure use a look ahead search, which may be implemented as a tree search. Each node in the tree represents a scheduling state of the cell, with actions linking the nodes representing allocations of radio resources, such as a PRB, to users. Search tree solutions are usually used for solving sequential problems. In the present disclosure, it is proposed to use a search tree to address a problem according to which there are a large number of possible combinations of actions, and to approach the problem as a sequential series of individual actions. Monte Carlo Tree Search (MCTS) is one of several solutions available for efficient tree search. MCTS is suitable for game plays and may be used to implement the look ahead search of methods according to the present disclosure.

As the scheduling problem is not sequential by nature (in contrast for example to the games of Go and Chess, which are sequential by nature), the structure of the search tree is to some degree variable according to design parameters. For example, the scheduling problem may be approached sequentially over PRBs, considering each PRB in turn and selecting user(s) to allocate to the PRB, or over users, considering each user in turn and selecting PRB(s) to allocate to the user. Taking a realistic example of 50 PRBs and between 0 and 10 users, an approach that is sequential over PRBs would result in a deep and narrow search tree, while an approach that is sequential over users would result in a search tree that is shallow and wide. The structure of the search tree may also be adjusted by varying the number of PRBs or users considered in each layer of the search tree. For example, in a tree that implements a search that is sequential over PRBs, each level in the search tree could schedule two PRBs instead of one. This would mean that the number of actions in each step increases exponentially but the depth of the tree is reduced by a factor 2.

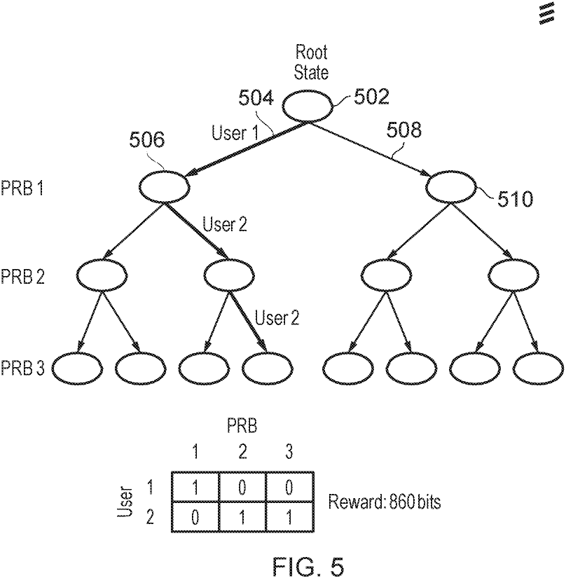

FIG. 5 illustrates a simple scheduling example demonstrating the above discussed concept. In the example of FIG. 5, two users are allocated on three PRBs, and there is always only one user allocated per PRB (described as frequency selective scheduling). It will be appreciated that this is significantly simpler than the realistic scenario of between 0 and 10 users, 50 PRBs and the option of MU-MIMO etc. However the simple example is sufficient to demonstrate the concept of using a search tree for a sequential approach to resource scheduling. In the example of FIG. 5, scheduling is performed sequentially over PRBs starting with PRB 1.

Referring to FIG. 5, in the root state 502, neither user has yet been scheduled on any of the available PRBs. The arrows leading away from the root state indicate resource allocations for PRB1. The left pointing arrow 504 allocates User 1 to PRB1, resulting in child node 506. The right pointing arrow 508 allocates User 2 to PRB1, and results in child node 510. With only 2 users and 3 PRBs, and only one user scheduled per PRB, it is possible to draw the full search tree, with the nodes of the bottom row of the search tree representing the scheduling decisions available (that is all allowed combinations of the 2 users and 3 PRBs). In the example illustrated in FIG. 5, User 1 is scheduled on PRB 1, and User 2 is scheduled on both PRB 2 and PRB 3. A reward is received when all users are scheduled. This reward is a measure of the success of the scheduling, and in the illustrated example is the total throughput achieved: 860 bits. This reward is calculated by calculating the channel quality for the users, performing link adaptation (i.e. calculating the required Modulation and Coding Scheme (MCS)) and calculating the throughput based on the MCS. For the illustrated problem, with b=2 users, d=3 PRBs and scheduling 1 user per PRB the number of possible solutions is 2^3=8. As mentioned above, owing to the very limited number of solutions, this problem can easily be solved by an exhaustive search, i.e. by evaluating the performance of all potential solutions.

A more complex scheduling example is now considered, in which there are b=2 users and d=15 PRBs. Even if the new example still schedules only 1 user per PRB, the number of possible solutions becomes 2^15=32768. This takes approximately 10 seconds per scheduling epoch to evaluate on a standard laptop using exhaustive search. This example is therefore already too complex for exhaustive search, as scheduling needs to be done during each TTI, and must therefore be performed in less than 1 ms. For examples considering Multi-user MIMO scheduling, the number of possible scheduling combinations grows even more quickly. For a situation involving d PRBs, and in which k users out of n active users are selected for scheduling, the branching factor of the search tree (that is the number of child nodes generated by a single node) becomes:

$$b = n ! \left(n - k\right) !$$

and the number of possible combinations becomes b^d. For realistic values of k, n and d: for example k=2 co-scheduled users, n=4 active users and d=15 PRBs, the number of possible scheduling solutions is of the order of 10⁶⁵.

The above examples demonstrate the fact that, owing to the exponential increase in the number of possible solutions, any solution based on exhaustive search is out of the question for practical problems. Examples of the present disclosure therefore propose to perform look ahead search offline in a simulated environment, and to use MCTS to efficiently explore scheduling decisions. The MCTS is guided by a neural network, and builds training data that may be used to improve the performance of the neural network. The neural network may then be used independently of MCTS during a live phase to perform online resource scheduling.

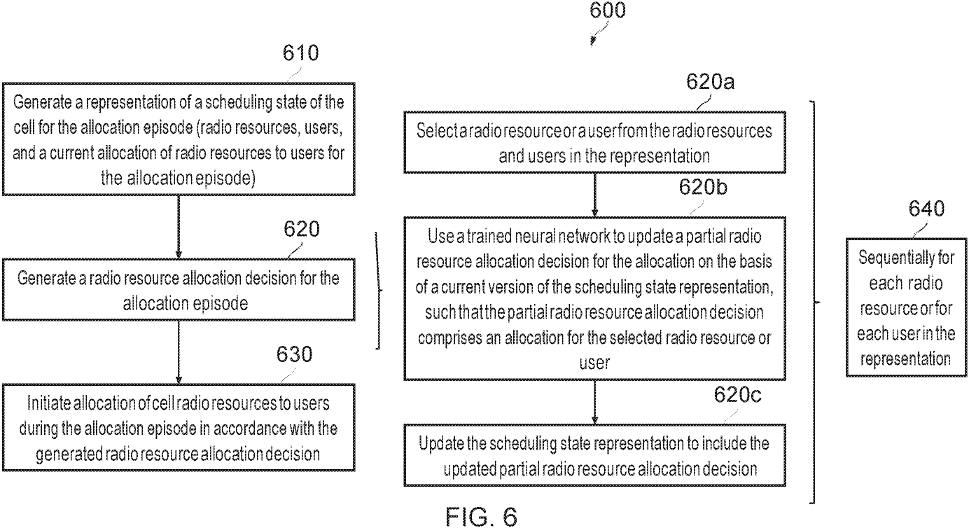

FIGS. 6 to 11 are flow charts illustrating methods which may be performed by a scheduling node and a training agent according to different examples of the present disclosure. The flow charts of FIGS. 6 to 11 are presented below, followed by a detailed discussion of how different process steps illustrated in the flow charts may be implemented according to examples of the present disclosure.

FIG. 6 is a flow chart illustrating process steps in a method 600 for managing allocation of radio resources to users in a cell of a communication network during an allocation episode. The allocation episode may for example be a TTI, or may be any other suitable allocation episode according to the nature of the communication network. The radio resources may be frequency resources, and may for example comprise PRBs of an LTE or 5G communication network, other examples of radio resources may be envisaged according to the nature of the communication network. The users may comprise any user device that is operable to connect to the communication network. For example the user may comprise a wireless device such as a User Equipment (UE), or any other device operable to connect to the communication network. The user device may be associated with a human user or with a machine, and may also be associated with a subscription to the communication network or to another communication network, if the device is roaming. The method may be performed by a scheduling node, which may for example comprise a base station. The scheduling node may be a physical or virtual node, and may be instantiated in any part of a logical base station node, which itself may be divided between a Baseband Unit (BBU) and one or more Remote Radio Heads (RRHs).

Referring to FIG. 6, the method 600 comprises, in a first step 610, generating a representation of a scheduling state of the cell for the allocation episode. The scheduling state representation includes radio resources of the cell that are available for allocation during the allocation episode (for example PRBs available for allocation), users requesting allocation of cell radio resources during the allocation episode, and a current allocation of cell radio resources to users for the allocation episode. The current allocation of radio resources to users for the allocation episode may for example be represented as a matrix having dimensions of (number of users) × (number of PRBs), with a 1 entry in the matrix indicating that the corresponding user has been allocated to the corresponding PRB. At the beginning of scheduling for a scheduling episode, the matrix illustrating current allocation of users to radio resources may be an all zero matrix, and this may be updated progressively as allocations are selected for individual users or radio resources, as discussed below.

In step 620, the method 600 comprises generating a radio resource allocation decision for the allocation episode. The radio resource allocation decision may be represented in the manner discussed above for a current allocation in the scheduling state representation. That is the radio resource allocation decision for the scheduling episode may comprise a matrix having dimensions of (number of users) × (number of PRBs), with a 1 entry in the matrix indicating that the corresponding user has been allocated to the corresponding PRB. The radio resource allocation decision represents the final allocation of resources to users for the scheduling episode. As illustrated in FIG. 6, generating the radio resource allocation decision may comprise performing a series of steps sequentially for each radio resource or for each user in the representation. For the purposes of the present disclosure, performing the steps “sequentially” for each radio resource or user refers to the performance of the steps with respect to each radio resource or each user individually and in turn: one after another, and does not imply that the users or radio resources are considered in any particular order. The order in which individual resources or users are considered may be random or may be selected according to requirements or features of a particular deployment or scenario.

Referring still to FIG. 6, for each radio resource or for each user in the representation of the scheduling state of the cell, the method comprises selecting a radio resource or a user from the radio resources and users in the representation in step 620a, and using a trained neural network to update a partial radio resource allocation decision for the allocation episode on the basis of a current version of the scheduling state representation in step 620b. The partial radio resource allocation decision is updated such that it comprises an allocation for the radio resource or user selected in step 620a. The partial radio resource allocation decision may thus also comprise a matrix having dimensions of (number of users) × (number of PRBs), with a 1 entry in the matrix indicating that the corresponding user has been allocated to the corresponding PRB. For the first selected user or radio resource of the scheduling interval, the partial radio resource allocation decision may initially comprise an all zero matrix, and updating the partial radio resource allocation decision may comprise introducing 1 s into the matrix to represent an allocation for the user or resource selected at step 620a. In this manner, as the steps 620a to 620c are performed for each of the resources or users in turn, columns or rows of the matrix will successively change from all zero to including non-zero entries representing allocations of radio resources to users. In step 620c, the scheduling state representation generated at step 610 is updated to include the updated partial radio resource allocation decision. In this manner, with each performance of step 620c, the current allocation of users to radio resources in the scheduling state representation is replaced with the newly updated partial radio resource allocation decision. Once steps 620a to 620c have been performed for the last radio resource or last user in the scheduling interval, the partial radio resource allocation decision will become the radio resource allocation decision, and the scheduling state representation will include this radio resource allocation decision as the current allocation of users to radio resources.

Once the steps 620a to 620c have been performed sequentially for each user or each radio resource in the scheduling state representation, the method 600 comprises initiating allocation of cell radio resources to users during the allocation episode in accordance with the generated radio resource allocation decision.

The method 600 thus uses a neural network to select radio resource allocations which together form a radio resource allocation decision for a cell during an allocation episode. A distinguishing feature of the method 600 is the framing of the scheduling problem as a sequential task, so that the neural network generates an allocation decision sequentially for each user or each radio resource (for example PRB) in the allocation episode (for example TTI). This is in contrast to existing processes in which extensive domain knowledge is used to design heuristics that approach the problem as a whole. This is also different to the “live” approach used by AlphaZero, in which MCTS is used to select moves during live play against a human player or competing game play algorithm.

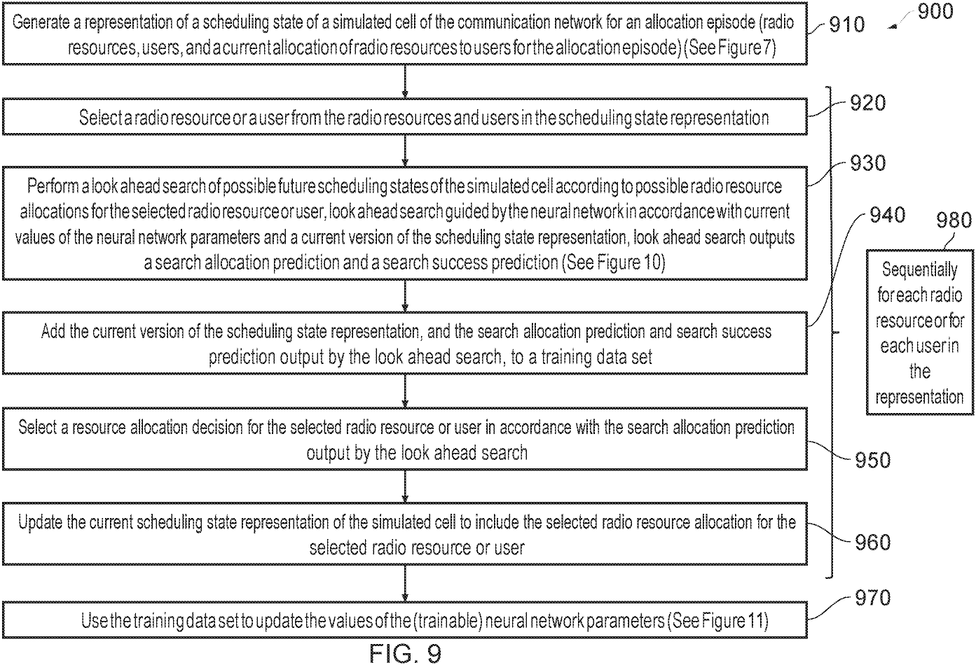

According to examples of the present disclosure, the neural network used in the method 600 may be trained using a method 900, illustrated in FIG. 9 and discussed in greater detail below.

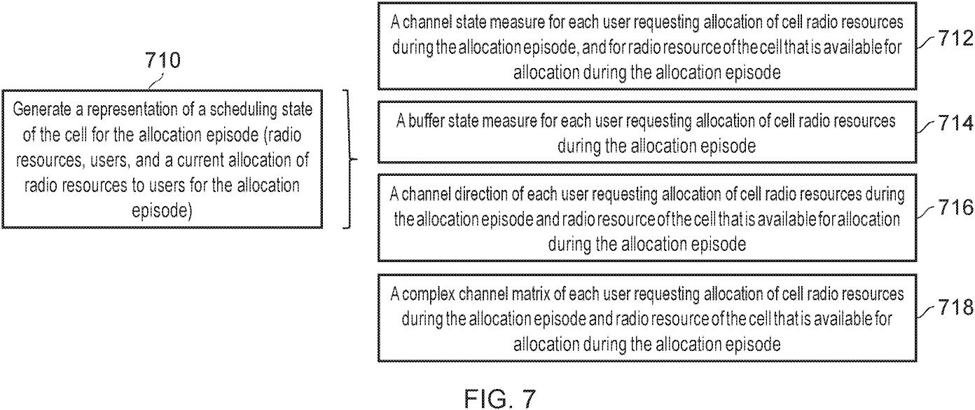

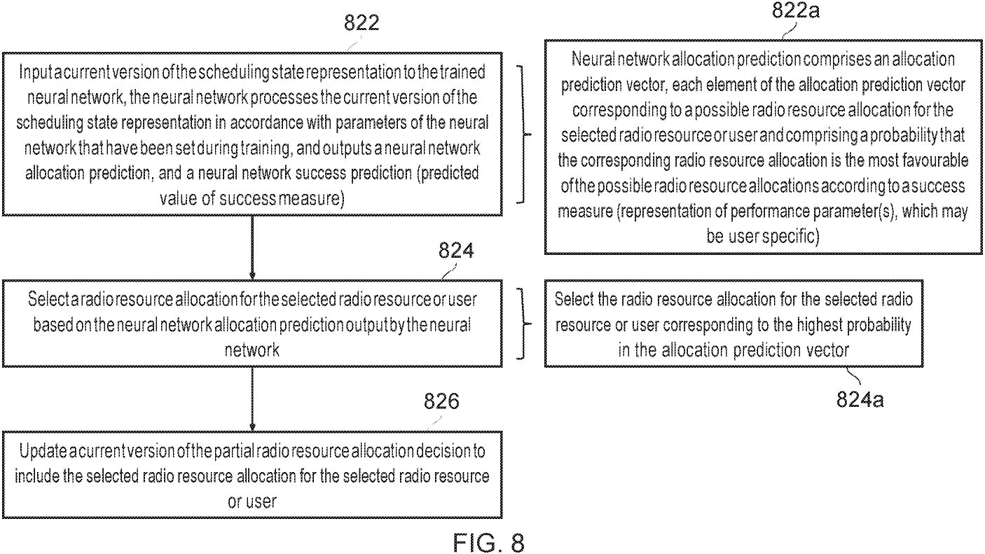

FIGS. 7 and 8 illustrate in further detail certain steps of the method 600. FIG. 7 illustrates features that may be included within the representation of a scheduling state that is generated at step 610 of the method 600. Referring to FIG. 7, the representation of a scheduling state generated at step 710 may for example include a channel state measure for each user requesting allocation of cell radio resources during the allocation episode, and radio resource of the cell that is available for allocation during the allocation episode, as shown at 712. The channel state measure may comprise SINR, and that the SINR may be SINR disregarding inter user interference within the cell. In this manner, the channel state measure does not need to be updated in a MU-MIMO or frequency selective scheduling setting. The channel state measure also does not have to be updated in a frequency selective scheduling setting, although SINR doesn’t change when new users are scheduled in this setting, as there is no inter-UE interference and therefore the single user SINR is the same as the actual SINR. Interference from user traffic in other cells may be present, or may in some cases be regarded as noise.

The representation of a scheduling state generated at step 710 may also include a buffer state measure for each user requesting allocation of cell radio resources during the allocation episode, as shown at 714, and/or, for example in cases of MU-MIMO, a channel direction of each user requesting allocation of cell radio resources during the allocation episode and radio resource of the cell that is available for allocation during the allocation episode, as shown at 716. In further examples, the scheduling state representation may further include a complex channel matrix of each user requesting allocation of cell radio resources during the allocation episode and radio resource of the cell that is available for allocation during the allocation episode. Such a complex channel matrix may be used in cases of MU-MIMO. As mentioned above, the SINR in the scheduling state representation may comprise the SINR excluding intra-cell inter-user interference. In some examples, the channel direction element of the scheduling state representation may enable the neural network to implicitly estimate the resulting SINR when two or more users are scheduled on the same radio resource. In some examples, with only the direction of the channel it may be difficult to estimate the resulting SINR when multiple users are scheduled on the same PRB, as the amplitude of the channel would be needed as well. In such examples, the complex channel matrix element of the scheduling state representation may be used for this purpose.

FIG. 8 illustrates one way in which the step 620b of using a trained neural network to update a partial radio resource allocation decision for the allocation episode on the basis of a current version of the scheduling state representation, such that the partial radio resource allocation decision comprising an allocation for the selected radio resource or user, may be carried out. Referring to FIG. 8, in a first step 822, using a trained neural network to update a partial radio resource allocation decision for the allocation episode may comprise inputting a current version of the scheduling state representation to the trained neural network, wherein the neural network processes the current version of the scheduling state representation in accordance with parameters of the neural network that have been set during training, and outputs a neural network allocation prediction.

The neural network may also output a neural network success prediction comprising a predicted value of the success measure for the current scheduling state of the cell. The predicted value of the success measure may comprise the predicted value in the event that a radio resource allocation decision is selected in accordance with the neural network allocation prediction output by the neural network. This neural network success prediction may not be used during the method 600, representing the live phase of resource scheduling, but rather used only in training, as discussed below with reference to FIG. 9. During the method 600, representing the live phase of resource scheduling, only the neural network allocation prediction may be used to select a radio resource allocation, as discussed below.

As illustrated at 822a, the neural network allocation prediction may comprise an allocation prediction vector, each element of the allocation prediction vector corresponding to a possible radio resource allocation for the selected radio resource or user, and comprising a probability that the corresponding radio resource allocation is the most favourable of the possible radio resource allocations according to a success measure. The success measure may comprise a representation of at least one performance parameter for the cell during the allocation episode. The performance parameter may represent performance over the duration of the allocation episode (for example the TTI) minus the time taken to schedule resources for the allocation episode.

In some examples, the success measure may comprise a combined representation of a plurality of performance parameters for the cell over the allocation episode. One or more of the performance parameters may comprise a user specific performance parameter. For example, the Quality of Service Class Identifier (QCI) of users may be taken into account, to ensure that the success measure is representative of network performance as measured against individual user requirements. In such examples, performance parameters may be weighted differently for different users depending on their QCI. 3GPP provides some guidance as to how each QCI maps to the corresponding performance requirements, and a table (QCI->performance requirements) may be used to guide how the success measure is generated.

In some examples, the method 600 may further comprise selecting a success measure for radio resource allocation for the allocation episode. The success measure may be selected by a network operator in accordance with one or more operator priorities for the allocation episode. Examples of performance parameters that may contribute to the success measure include total cell throughput, latency, etc.

Referring still to FIG. 8, using a trained neural network to update a partial radio resource allocation decision for the allocation episode may further comprise selecting a radio resource allocation for the selected radio resource or user based on the neural network allocation prediction output by the neural network in step 824. This may comprise selecting the radio resource allocation corresponding to the highest probability in the neural network allocation prediction vector, as illustrated at 824a.

In step 826, using a trained neural network to update a partial radio resource allocation decision for the allocation episode may comprise updating a current version of the partial radio resource allocation decision to include the selected radio resource allocation for the selected radio resource or user.

As discussed above, the neural network used in step 620b, for example as set out in steps 822 to 826, may have been trained using a method according to examples of the present disclosure.

FIG. 9 is a flow chart illustrating process steps in a method 900 for training a neural network having a plurality of parameters, wherein the neural network is used for selecting a radio resource allocation for a radio resource or user in a communication network. As for the method 600 above, the radio resource may be a frequency resource, and may for example comprise a PRB of an LTE or 5G communication network. The method may be performed by a training agent, which may for example comprise an application or function, and which may be running within a Radio Access node such as a base station, a Core network node or in a cloud or fog deployment. During training, the training agent is instantiated in a simulated environment (a simulated cell), as discussed in greater detail below.

Referring to FIG. 9, the method 900 comprises, in a first step 910, generating a representation of a scheduling state of a simulated cell of the communication network for an allocation episode, wherein the scheduling state representation includes radio resources of the simulated cell that are available for allocation during the allocation episode, users requesting allocation of simulated cell radio resources during the allocation episode, and a current allocation of simulated cell radio resources to users for the allocation episode. The allocation episode may for example be a TTI, or may be any other suitable allocation episode according to the nature of the communication network. The simulated cell may exhibit scheduling parameters, such as channel states and buffer states, which are representative of conditions which may be experienced by a live cell of the communication network at different times and under different network conditions. The different features that may be included within the representation of a scheduling state that is generated at step 910 of the method 900 are illustrated in FIG. 7, and reference is made to the description of FIG. 7 above, which is not repeated here.

As illustrated in FIG. 9, the method 900 then comprises performing a series of steps sequentially for each radio resource or for each user in the representation generated at step 910. As discussed above with reference to FIG. 6, for the purposes of the present disclosure, performing the steps “sequentially” for each radio resource or user refers to the performance of the steps with respect to each radio resource or each user individually and in turn: one after another, and does not imply that the users or radio resources are considered in any particular order. The order in which individual resources or users are considered may be random or may be selected according to requirements or features of a particular deployment or scenario.

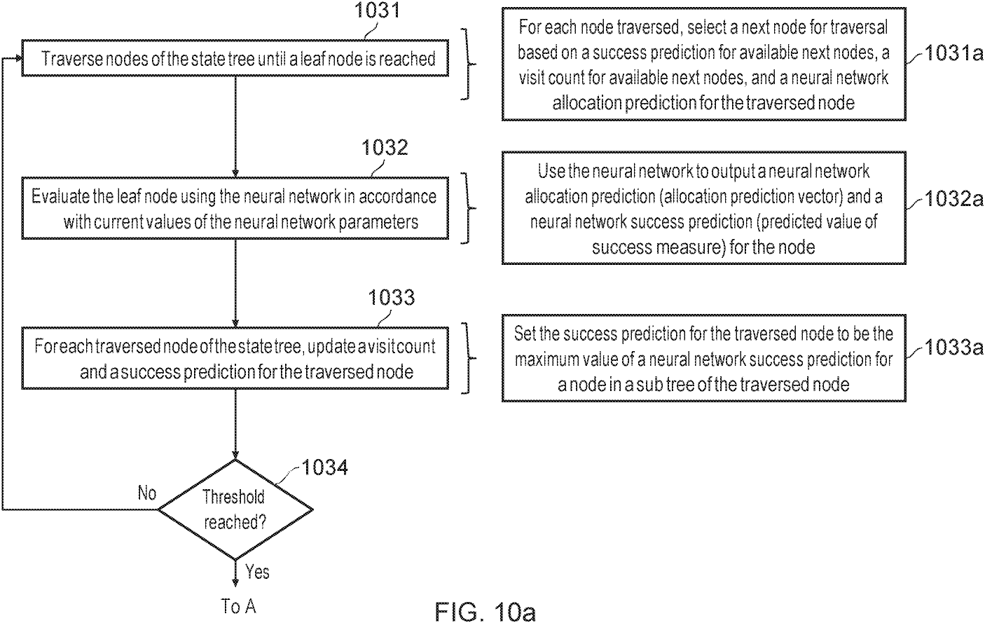

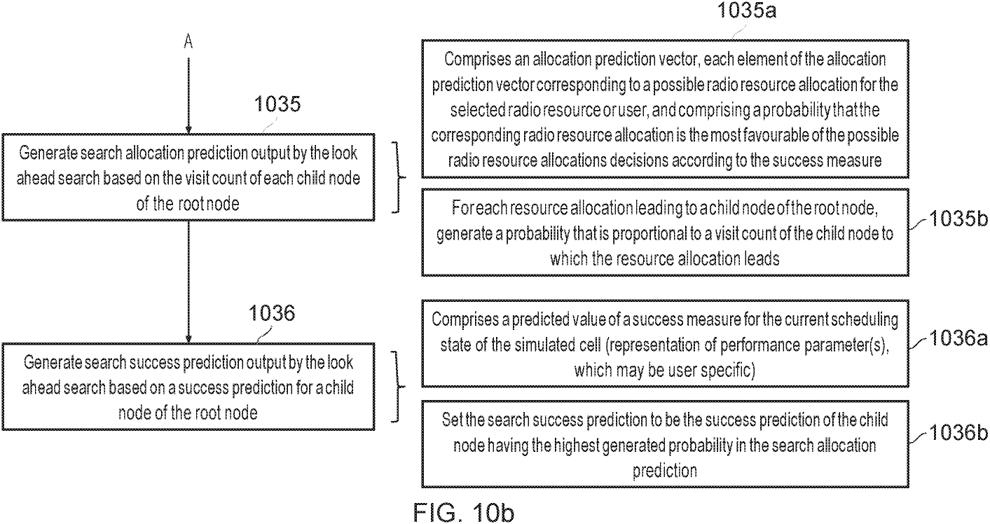

Referring to FIG. 9, for each radio resource or for each user in the representation of the scheduling state of the cell, the method comprises selecting a radio resource or a user from the radio resources and users in the scheduling state representation in step 920. The method then comprises performing a look ahead search of possible future scheduling states of the simulated cell according to possible radio resource allocations for the selected radio resource or user in step 930. The look ahead search is guided by the neural network to be trained in accordance with current values of the neural network parameters and a current version of the scheduling state representation. The look ahead search outputs a search allocation prediction and a search success prediction. Further detail of how the look ahead search may be implemented is illustrated in FIG. 10, which is discussed below.

Referring still to FIG. 9, the method 900 comprises adding the current version of the scheduling state representation, and the search allocation prediction and search success prediction output by the look ahead search in step 930, to a training data set in step 940. The method then comprises, in step 950, selecting a resource allocation for the selected radio resource or user in accordance with the search allocation prediction output by the look ahead search and, in step 960, updating the current scheduling state representation of the simulated cell to include the selected radio resource allocation for the selected radio resource or user. Once steps 920 to 960 have been performed for each radio resource or each user in the simulated cell, the method further comprises using the training data set to update the values of the neural network parameters. It will be appreciated that the neural network parameters that are updated may comprise the trainable parameters, that is the weights of the neural network, as opposed to the hyper parameters of the neural network, which may be set by an operator or administrator.

The method 900 thus uses a look ahead search, such as MCTS, to generate training data for training the neural network, wherein the look ahead search is guided by the neural network. The look ahead search of possible future scheduling states generates an output comprising an allocation prediction and a predicted value of a success measure. The look ahead search is performed sequentially for each user or radio resource in the simulated cell for the allocation episode, and the outputs of the look ahead search, together with the state representation, are added to a training data set for training the neural network. According to examples of the present disclosure, the method steps performed sequentially for each radio resource or user may be repeated until the training data set contains a quantity of data that is above a threshold value, or for a threshold number of iterations. If a sliding window of training data is used (as discussed in greater detail below) then the number of historical iterations can be set as a parameter to determine the size of the sliding window.

FIG. 10 illustrates one way in which the step 930 of performing a look ahead search may be carried out. According to some examples, performing a look ahead search may comprise performing a tree search of a state tree comprising nodes that represent possible future scheduling states of the simulated cell, the state tree having a root node that represents a current scheduling state of the simulated cell. Referring to FIG. 10, performing the tree search may comprise, in a first step 1031, traversing nodes of the state tree until a leaf node is reached. As illustrated at 1031a, this may comprise, for each node traversed, selecting a next node for traversal based on a success prediction for available next nodes, a visit count for available next nodes, and a neural network allocation prediction for the traversed node. In some examples, selection of a next node for traversal may be performed by selecting for traversal the node having the highest Polynomial Upper Confidence Bound for Trees, or Max Q+U, as discussed in detail above in the introduction to MCTS. Traversing the state tree may thus correspond the select step (a), from the introduction to MCTS provided above. As discussed in greater detail below, the Q used in selecting a next node for traversal may be a maximum value of Q as opposed to a mean value as set out in the introduction to MCTS provided above in the context of the AlphaZero algorithm.

Referring still to FIG. 10, once a leaf node is reached, performing the tree search may comprise, in step 1032, evaluating the leaf node using the neural network in accordance with current values of the neural network parameters. At the start of the method, the neural network parameters may be initiated to any suitable value. As illustrated at 1032a, evaluating the leaf node may comprise using the neural network to output a neural network allocation prediction and a neural network success prediction for the node. This step may thus correspond to the expand and evaluate step (b) from the introduction to MCTS provided above. In some examples, the neural network allocation prediction comprises an allocation prediction vector, each element of the allocation prediction vector corresponding to a possible radio resource allocation for the selected radio resource or user, and comprising a probability that the corresponding radio resource allocation is the most favourable of the possible radio resource allocations according to a success measure. In such examples, the neural network success prediction comprises a predicted value of the success measure for the current scheduling state of the cell. The predicted value of the success measure may comprise the predicted value in the event that a radio resource allocation is selected in accordance with the neural network allocation prediction output by the neural network.

In step 1033, performing the tree search then comprises, for each traversed node of the state tree, updating a visit count and a success prediction for the traversed node. Updating a visit count may for example comprise incrementing the visit count by one. In some examples, updating a success prediction for the traversed node comprises setting the success prediction for the traversed node to be the maximum value of a neural network success prediction for a node in a sub tree of the traversed node. This step may therefore correspond to the backup step (c) of the introduction to MCTS provided above. It will be appreciated that in the introduction to MCTS provided above, a mean value of the success prediction is back propagated up the search tree. Using a mean value may be appropriate for a self-play phase of game play, in which uncertainty is generated by the adversarial nature of the game play, with the algorithm unable to know the moves that will be taken by an opponent and the impact such moves may have upon the game outcome. However, in methods related to scheduling of resources, the uncertainty generated by an opponent is absent, so the value of the success measure that is back propagated through the search tree may be the maximum value of a neural network success prediction for a node in a sub tree of a traversed node, as illustrated at 1033a.

As illustrated in FIG. 10, performing the tree search may further comprise repeating the steps of traversing nodes of the state tree until a leaf node is reached 1031, evaluating the leaf node using the neural network in accordance with current values of the neural network parameters 1032, and, for each traversed node of the state tree, updating a visit count and a success prediction for the traversed node 1033, a threshold number of times. A check may be made at step 1034 as to whether the threshold number has been reached. The value of the threshold may be a configurable parameter, which may be set by an operator or administrator.

Referring now to FIG. 10b, performing the tree search then comprises generating the search outputs. In step 1035, performing the tree search comprises generating the search allocation prediction output by the look ahead search based on the visit count of each child node of the root node. As illustrated at 1035a, the search allocation prediction comprises in some examples an allocation prediction vector, each element of the allocation prediction vector corresponding to a possible radio resource allocation for the selected radio resource or user, and comprising a probability that the corresponding radio resource allocation is the most favourable of the possible radio resource allocations according to the success measure. As illustrated at 1035b, generating the search allocation prediction may comprise, for each resource allocation leading to a child node of the root node, generating a probability that is proportional to a visit count of the child node to which the resource allocation leads.

In step 1036, performing the tree search comprises generating the search success prediction output by the look ahead search based on a success prediction for a child node of the root node. As illustrated at 1036a, the search success prediction may comprise a predicted value of a success measure for the current scheduling state of the simulated cell. The predicted value of the success measure may comprise the predicted value in the event that a radio resource allocation is selected in accordance with the search allocation prediction output by the look ahead search.

As discussed above with reference to the method 600 and FIG. 8, the success measure comprises a representation of at least one performance parameter for the simulated cell over the allocation episode. The success measure may comprise a representation of at least one performance parameter for the cell during the allocation episode.

In some examples, the success measure may comprise a combined representation of a plurality of performance parameters for the cell over the allocation episode. One or more of the performance parameters may comprise a user specific performance parameter. For example, the Quality of Service Class Identifier (QCI) of users may be taken into account, to ensure that the success measure is representative of network performance as measured against individual user requirements. In such examples, performance parameters may be weighted differently for different users depending on their QCI. The success measure may be selected by a network operator in accordance with one or more operator priorities for the allocation episode. Examples of performance parameters that may contribute to the success measure include total cell throughput, latency, etc.

As illustrated at 1036b, generating the search success prediction based on a success prediction for a child node of the root node may comprise setting the search success prediction to be the success prediction of the child node having the highest generated probability in the search allocation prediction.

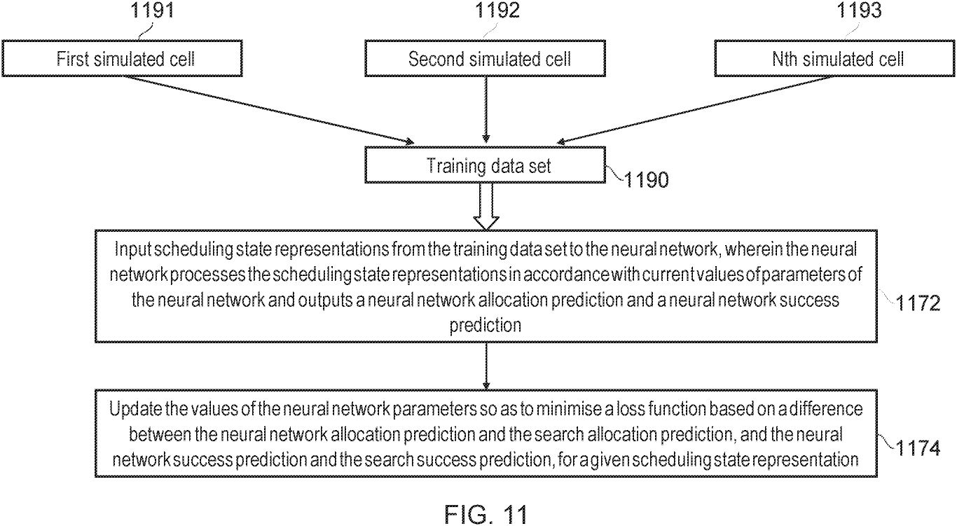

According to examples of the present disclosure, the method 900 may further comprise generating a representation of a scheduling state of a new simulated cell of the communication network for an allocation episode, and repeating the steps of the method 900 for the new simulated cell. The new simulated cell may differ from the original simulated cell in various respects, for example comprising different channel states and buffer states. The tuples of state representation, search allocation prediction and search success prediction generated by the look ahead search for the new simulated cell may be added to the same training data set as the tuples generated for the original simulated cell. In some examples, the steps of the method 900 may be carried out for multiple simulated cells in parallel in order to generate a single training data set, which is then used to update the parameters of the neural network that guides the look ahead search for all simulated cells. This situation is illustrated in FIG. 11, with first, second and Nth simulated cells 1191, 1192, and 1193 all being used to generate training data for a single training data set 1190. This training data set is then used to update the parameters of the neural network. As illustrated in FIG. 11, using the training data set to update the values of the neural network may comprise, in step 1172, inputting scheduling state representations from the training data set to the neural network, wherein the neural network processes the scheduling state representations in accordance with current values of parameters of the neural network and outputs a neural network allocation prediction and a neural network success prediction. Using the training data set to update the parameters of the neural network may then comprise, in step 1174, updating the values of the neural network parameters so as to minimise a loss function based on a difference between the neural network allocation prediction and the search allocation prediction, and the neural network success prediction and the search success prediction, for a given scheduling state representation.

It will be appreciated that the use of a plurality of simulated cells to generate training data for updating the parameters of the neural network may ensure that the neural network is not over fitted to any particular set of channel states or other conditions, and is able to select optimal or near optimal resource allocations for cells under a wide range of different network conditions.

FIGS. 6 to 11 discussed above provide an overview of methods which may be performed by a scheduling node and a training agent according to different examples of the present disclosure. The methods involve the generation of training data for use in training a neural network, training the neural network, and using a neural network to generate a radio resource allocation decision for a cell of a communication network during an allocation episode. There now follows a detailed discussion of how different process steps illustrated in FIGS. 6 to 11 and discussed above may be implemented according to examples of the present disclosure. The example implementations discussed below envisage allocation of radio resources in the form of Physical Resource Blocks (PRBs) to one or more users in a cell (for live scheduling) or simulated cell (for training).

The methods discussed above envisage the generation of a representation of a scheduling state of a cell or simulated cell, as illustrated in FIG. 7. In one example implementation, the features shown in FIG. 7 that may be included within the representation of a scheduling state may be represented as set out in detail below.
Current user allocation
   Current user allocation may be represented as a matrix of size (number of Users × number of PRBs) indicating which users have been scheduled on which PRBs. A “one” in element (j,k) indicates that PRB k is allocated to user j. During a scheduling episode this matrix is the only part of the scheduling state representation that will change, i.e. as new PRBs are scheduled the corresponding elements are sequentially changed from zero to one.
   Channel state (SINR)
   The channel state may represented by the SINR disregarding inter-user interference.
Buffer State
   The buffer state may be represented by the number of bits in the RLC buffer for a user. As the buffer state is one value per UE, it is copied to match the size of the other components of the scheduling state representation, i.e. a matrix of size (number of Users × number of PRBs).
Channel direction
   The channel direction of each user and PRB may be included, and may be represented as a complex channel matrix for each user and PRB. This may enable the neural network to implicitly estimate the resulting SINR when two or more users are scheduled on the same PRB. The size of this state component may be (number of Users x number of PRBs × number of Elements) where the number of Elements is the number of elements in the channel matrix, which is 4 for a 2×2 channel matrix.

The size of the resulting scheduling state representation matrix is (number of Users × number of PRBs × number of State Features).

The actions that may be taken according to the scheduling and training methods disclosed herein comprise the allocation of a PRB to a user. These allocations may be represented as a matrix with the Users and PRBs. A “one” in position (i,j) in this matrix indicates that that PRB j is allocated to UE i. This corresponds to the partial radio resource allocation decision of the method 600, which is gradually updated to include allocations for each of the users or radio resources (depending upon whether the method is performed sequentially over users or sequentially over radio resources). When an action is taken (that is when an allocation is selected), the action matrix is combined with the current user allocation part of the state representation to form an updated state representation. This combination is done using logical OR, i.e. elements that are set to one in any of the action matrix and the user allocation matrix are one in the updated state matrix.

A success measure is used to indicate the quality of a scheduling decision. This success measure is a scalar, and may be based upon one or more parameters representing network performance. In one example, total throughput may be selected as the success measure, and calculated over a scheduling episode. In this example, the first step when calculating the reward is to calculate the transport block size that can be supported for each user given a certain block error rate target. Here the channel matrices for each user and each PRB may be used together with transmission power and received noise power and interference. When the transport block sizes per user have been calculated, the next step is to map this to a success measure. In a simple case the success measure is simply the sum rate, i.e. the sum of the allocated transport block sizes over the users. However, to support a more diverse set of services, the success measure can also be calculated based on other functions which may be different for different users. In order to support such user specific success measures, the scheduling state representation may contain information about the type of reward function to apply for each user.

The calculation of a success measure may be relatively costly. For this reason, although the most straightforward solution may be to calculate the success measure when a scheduling episode has finished, if the search tree is very deep it may be advantageous to estimate an intermediate reward, for example when half the PRBs have been allocated. In this case a non-zero reward can be back-propagated even though a final node has not been reached, which may simplify convergence for the algorithm in some scenarios.

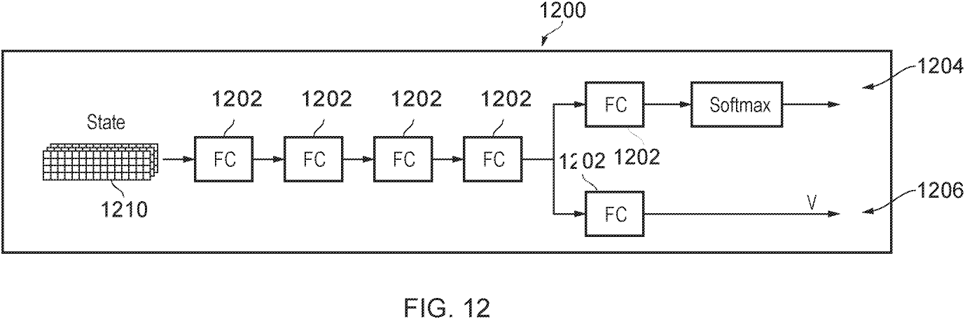

FIG. 12 illustrates a possible neural network architecture 1200 using fully connected (FC) layers 1202, i.e. layers of the form y = Wx + b, where W is a weight matrix and b is a bias vector. In the architecture of FIG. 12, each fully connected layer also has a Rectified Linear Unit activation function of the form y = max(0,x) connected to it. The architecture of FIG. 12 may be used to implement the neural network that is used to generate a radio resource allocation decision according to the method 600, and is trained according to the method 900. Referring to FIG. 12, the scheduling state representation matrix 1210 is input to the neural network by flatting it to a vector before feeding it to the network. The neural network has two heads, referred to as the policy head 1204 and value head 1206. The policy head 1204 outputs a policy vector containing resource allocation probabilities (the neural network allocation prediction), and the value head outputs the predicted value for the current state (the neural network success prediction). The policy head 1204 uses a softmax to normalize its output to a valid probability distribution over allocations. The part of the neural network architecture that is common to the two heads is called the stem which in the illustrated example consists of four fully connected layers. In other examples, a Convolutional Neural Network may be used in place of the fully connected layers illustrated in FIG. 12, and may in some circumstances provide improved results compared to the architecture including fully connected layers.

Normalizing the state representation matrix such that the different state components have similar value ranges can assist in ensuring that the neural network makes accurate predictions. In illustrated examples, the state representation matrix is scaled such that all values are within ±1. In a similar manner, target success measures may be normalized to be in the range 0 - 1. These normalization steps may assist in causing the network to converge more quickly.

As discussed above, the neural network is used to generate a resource allocation decision for a cell during a scheduling episode during live resource scheduling, and, during training, is used to guide the look ahead search that generates training data. An implementation of a look ahead search using MCTS is described in detail below.

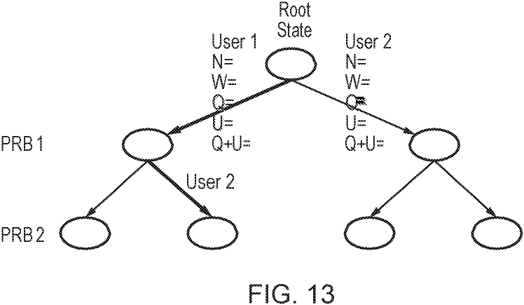

The MCTS procedure may be similar to that described above in the context of the AlphaZero algorithm, with the nodes of the state tree representing scheduling states of the cell. For sequential consideration of radio resources, each level of the state tree corresponds to a radio resource, or PRB. For sequential consideration of users, each level of the state tree corresponds to a user. The actions leading from one state to another are the allocations of radio resources to users. FIG. 13 illustrates two levels of a simple state tree representing two PRBs and two users.

Each potential action from a scheduling state (i.e. each potential allocation of a PRB to a user) stores four numbers:
N= The number of times action (or allocation) a has been taken from state s.
W= The total value of the next state
Q= the mean (or maximum) value of the next state
P= The prior probability of selecting action a as returned by the neural network

An example traverse of a state tree as illustrated above comprises:
1. Choose the action (allocation) that maximizes Q+U. Q is the mean or maximum value of the next state. U is a function of P and N that increases if an action has not been explored often, relative to the other actions, or if the prior probability that the action is the most favorable (returned by the neural network) is high. An equation for U is given above.
2. Continue to walk down the nodes of the state tree, each time selecting an action that maximizes Q+U, until a leaf node is reached. The scheduling state of the leaf node is then input to the neural network, which outputs the neural network allocation prediction vector, illustrated as the action probabilities vector p, and the neural network success prediction, illustrated as the value v of the state.
3. Backup previous edges to the root node. Each edge that was traversed to get to the leaf node is updated as follows:
   N → N+1,
   W → W+v,
   Q → max v for subtree

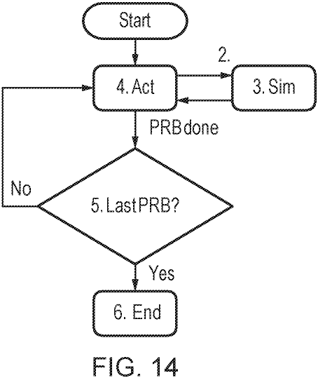

FIG. 14 is a flow chart illustrating MCTS according to an example of the present disclosure.
1. MCTS starts.
2. Function Act tells Function Sim to run a predefined number of MCTS simulations.
3. Sim generates a number of MCTS simulations. The steps in each MCTS simulation are as described above. The number of simulations (the number of traversals of the MCTS state tree) is set with a configurable parameter.
4. Act calculates action (allocation) values from the search tree for this PRB. The action values are used to derive a probability vector for which User to allocate for the next PRB.
5. If there are more PRBs to be scheduled for this TTI repeat 2-4 otherwise End.
6. End

MCTS is used in connection with simulated cells to generate training data for training the neural network. The neural network is trained to select optimal or near optimal resource allocations during live resource scheduling.

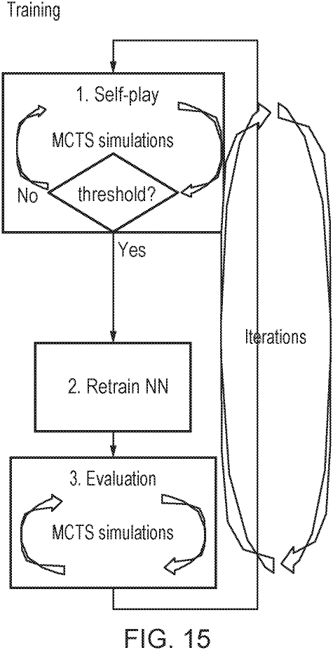

FIG. 15 is a flow chart illustrating training of the neural network. The training is performed off-line with a simulated environment, and the illustrated training loop is performed for a predefined number of iterations. Referring to FIG. 15, the stages of training are as follows:
1. Self-play: Run a number of MCTS simulations to create a dataset containing the current state, the value or predicted success measure of that state as predicted by MCTS (the search success prediction), and the allocation probabilities from that state, also predicted by MCTS (the search allocation prediction). The simulations are executed until enough data is available to start training the neural network, which may for example be when a configured volume threshold is reached.
2. Training: The trainable neural network parameters are updated using the training data set assembled from MCTS. The training data set may consist of only the data from the last self-play or may consist of data from the last trained data set together with a predefined subset of data from previous iterations, for example from a sliding window. The use of a sliding window may help to avoid overfitting on the last data set.
3. Evaluation: Implementation with the trained neural network and (deterministic) MCTS simulations is evaluated in order to assess performance.

It will be appreciated that in step 1 (Self-play), the actions (allocations) are selected during traversal of the state tree in MCTS in an explorative mode. This means that actions are selected based both on the predicted probability returned by the neural network and also on how often the action has been selected previously (for example using max Q + U as discussed above). In step 3 the actions (allocations) are selected in an exploitable mode. This means that the action with the highest probability is selected (deterministic). When the results from the evaluation step meet a required level of performance, for example the success measure in the evaluation step meets an expected level, the trained neural network can be used in the target environment, for example for live scheduling of radio resources in the communication network.

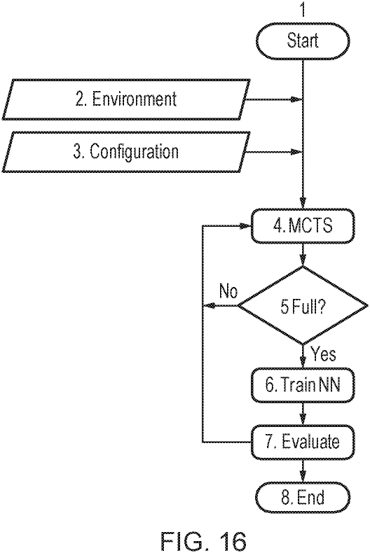

FIG. 16 illustrates the training loop in the form of a flow chart. Referring to FIG. 16, the following steps are performed:
1. Start of training
2. Environment generation: generate an Environment containing information about the current situation, including the number of PRBs and the number of users together with state information about each user such as SINR.
3. Configuration: multiple configuration parameters are available to control the execution of the algorithm, including for example the number of traversals of the state tree during MCTS, a volume threshold for training data before training is performed, a number of different simulated cells with different channel and buffer states to be used for generating the training data set, etc.
4. MCTS: The Monte Carlo Tree Search algorithm generates a search tree by simulating multiple searches in the tree for each PRB allocation (or user). See FIG. 14.
5. Update training data: once the MCTS search is complete, search allocation probabilities ⊓ are returned proportional to N, where N is the visit count of each action (allocation) from the root state. ⊓ and V for each state are input to a row in the data set. When the MCTS has been repeated for n simulations, i.e. controlled by a parameter set in step 3, a data set is generated with State, policy (search allocation predictions) and allocation success (search success prediction) (^{s}t, ^{Π}t^{,} ^{Z}t) .
6. Training: the neural network is trained using the training data set. The training is stopped when the training error is below a threshold or after a certain predefined number of training epochs.
7. Evaluation: when the training is completed, the model may be evaluated. The evaluation is performed by running MCTS with the trained neural network and monitoring the success measure. Step 4-7 are then repeated for a predefined number of iterations or until the success measure meets expectations.
8. The neural network model is ready to be used for online execution in a live system.

During live scheduling, the time period available for selecting resource allocations is limited by the duration of a scheduling episode. As mentioned above, the duration of a TTI is typically 1 ms or less. The present disclosure therefore proposes that during live scheduling, a resource allocation decision is generated using the trained neural network only, without performing MCTS. Scheduling is performed by using the trained neural network to generate, sequentially for each user or each radio resource, probability vectors for the most favorable allocation of resources to users. The allocation having the highest probability is selected from the policy probabilities. This equates to a single traverse of the state tree for each scheduling episode. The accuracy of predictions may be reduced compared to playing a number of MCTS simulations, but in this manner it may be ensured that the execution time remains compatible with the duration of a typical scheduling interval.

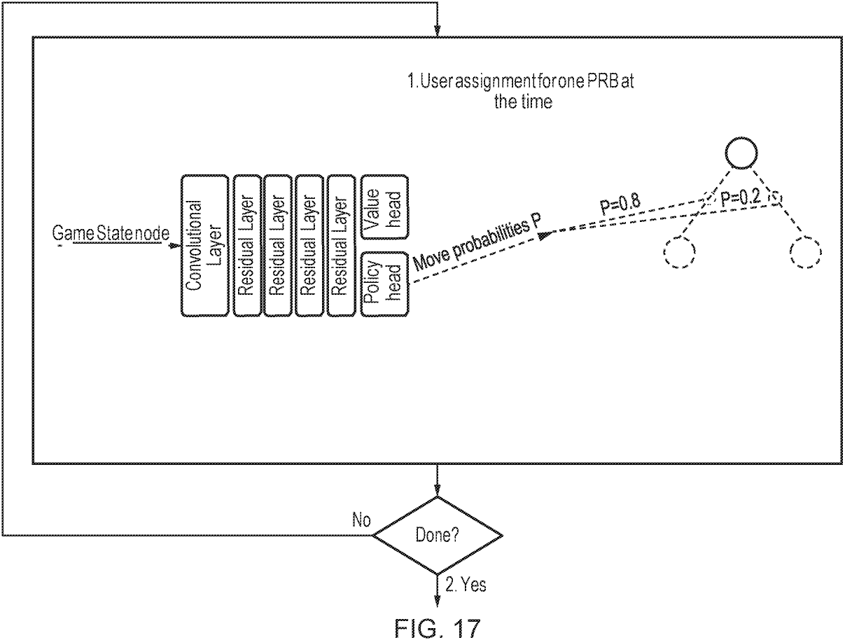

An overview of online resource allocation is provided in FIG. 17. Referring to FIG. 17, user assignment to each PRB is first performed sequentially over PRBs (or over users). For sequential assignment over PRBs, the process starts at the first PRB (root node) and allocates one PRB at a time. The trained neural network is used to predict the most favorable action (user(s) to allocate to the currently selected PRB) in each state. The action with the maximum probability is selected and the corresponding user(s) are marked as allocated in the state matrix. This step is repeated until all PRBs have been considered, and the state representation is updated to reflect the user allocation for each PRB.

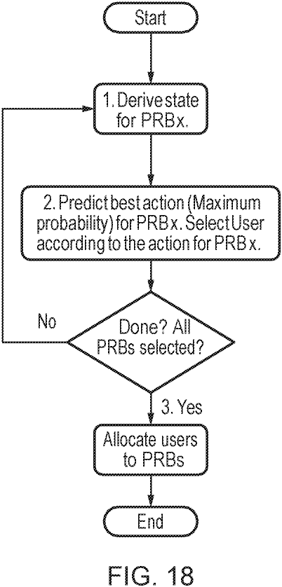

FIG. 18 illustrates live scheduling in the form of a flow chart. Referring to FIG. 18, the following steps are performed:

At the start of scheduling, a number of users are to be scheduled on a group of PRBs.
1. The current state representation for the next PRB to be scheduled is generated.
2. The policy probabilities for each user for the current PRB are predicted. The action (allocation) with the maximum probability is selected. A user is allocated to the current PRB in accordance with the selected action. Steps 1 and 2 are repeated for all PRBs.
3. When all PRBs have been considered, scheduling in accordance with the selected allocations is initialized and the scheduling is finished.

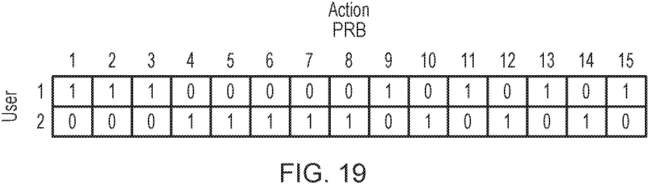

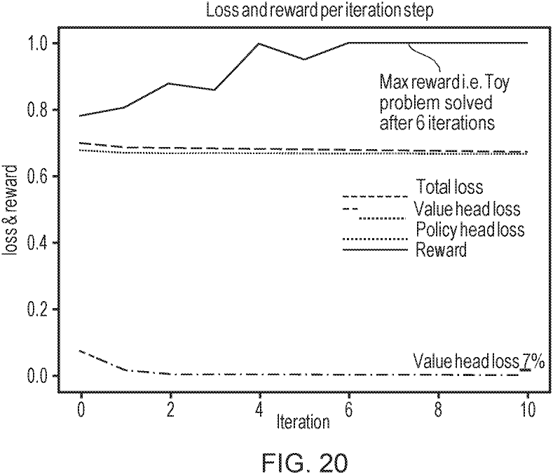

Concept testing has been performed to explore the performance of methods proposed in the present disclosure. The concept testing was performed for example scheduling situations in which the optimal scheduling PRB allocation was known in advance. One example situation for which testing was performed comprised 15 PRBs and 2 users with the optimal PRB allocation illustrated in FIG. 19. The results of the testing are illustrated in FIG. 20. As illustrated in FIG. 20, for this example situation, maximum success measure (illustrated as Reward in the Figure), and minimum loss, indicating solution of the problem, were reached after 6 iterations.

The methods discussed above are performed by a scheduling node and training agent respectively. The present disclosure provides a scheduling node and training agent which are adapted to perform any or all of the steps of the above discussed methods.

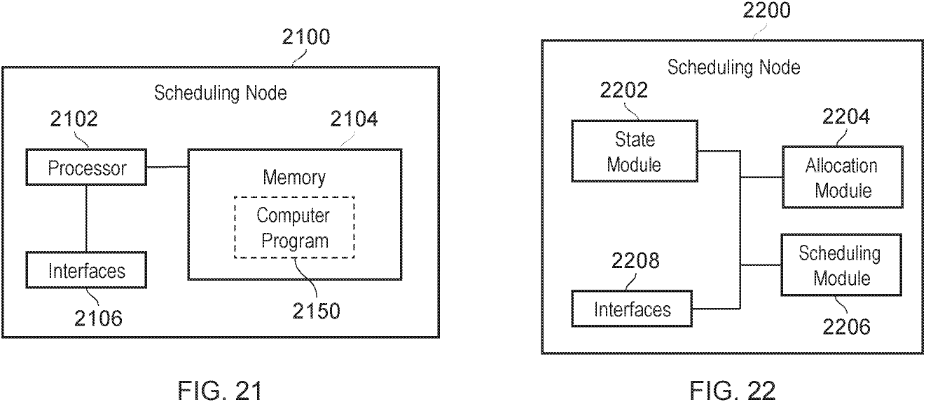

FIG. 21 is a block diagram illustrating an example scheduling node 2100 which may implement the method 600, as elaborated in FIGS. 6 to 8, according to examples of the present disclosure, for example on receipt of suitable instructions from a computer program 2150. Referring to FIG. 21, the scheduling node 2100 comprises a processor or processing circuitry 2102, and may comprise a memory 2104 and interfaces 2106. The processing circuitry 2102 is operable to perform some or all of the steps of the method 600 as discussed above with reference to FIGS. 6 to 8. The memory 2104 may contain instructions executable by the processing circuitry 2102 such that the scheduling node 2100 is operable to perform some or all of the steps of the method 600, as elaborated in FIGS. 6 to 8. The instructions may also include instructions for executing one or more telecommunications and/or data communications protocols. The instructions may be stored in the form of the computer program 2150. In some examples, the processor or processing circuitry 2102 may include one or more microprocessors or microcontrollers, as well as other digital hardware, which may include digital signal processors (DSPs), special-purpose digital logic, etc. The processor or processing circuitry 2102 may be implemented by any type of integrated circuit, such as an Application Specific Integrated Circuit (ASIC), Field Programmable Gate Array (FPGA) etc. The memory 2104 may include one or several types of memory suitable for the processor, such as read-only memory (ROM), random-access memory, cache memory, flash memory devices, optical storage devices, solid state disk, hard disk drive etc.

FIG. 22 illustrates functional modules in another example of scheduling node 2200 which may execute examples of the methods 600 of the present disclosure, for example according to computer readable instructions received from a computer program. It will be understood that the modules illustrated in FIG. 22 are functional modules, and may be realised in any appropriate combination of hardware and/or software. The modules may comprise one or more processors and may be integrated to any degree.

Referring to FIG. 22, the scheduling node 2200 is for managing allocation of radio resources to users in a cell of a communication network during an allocation episode. The scheduling node comprises a state module 2202 for generating a representation of a scheduling state of the cell for the allocation episode, wherein the scheduling state representation includes radio resources of the cell that are available for allocation during the allocation episode, users requesting allocation of cell radio resources during the allocation episode, and a current allocation of cell radio resources to users for the allocation episode. The scheduling node further comprises an allocation module 2204 for generating a radio resource allocation decision for the allocation episode by performing a series of steps sequentially for each radio resource or for each user in the representation. The steps comprise selecting, from the radio resources and users in the representation, a radio resource or a user, and using a trained neural network to update a partial radio resource allocation decision for the allocation episode on the basis of a current version of the scheduling state representation, such that the partial radio resource allocation decision comprises an allocation for the selected radio resource or user. The steps further comprise updating the scheduling state representation to include the updated partial radio resource allocation decision. The allocation module may comprise sub modules including a selection module, a neural network module, and an updating module to perform these steps. The scheduling node 2200 further comprises a scheduling module 2206 for initiating allocation of cell radio resources to users during the allocation episode in accordance with the generated radio resource allocation decision. The scheduling node 2200 may further comprise interfaces 2208.

FIG. 23 is a block diagram illustrating an example training agent 2300 which may implement the method 900, as elaborated in FIGS. 9 to 11, according to examples of the present disclosure, for example on receipt of suitable instructions from a computer program 2350. Referring to FIG. 23, the training agent 2300 comprises a processor or processing circuitry 2302, and may comprise a memory 2304 and interfaces 2306. The processing circuitry 2302 is operable to perform some or all of the steps of the method 900 as discussed above with reference to FIGS. 9 to 11. The memory 2304 may contain instructions executable by the processing circuitry 2302 such that the training agent 2300 is operable to perform some or all of the steps of the method 900, as elaborated in FIGS. 9 to 11. The instructions may also include instructions for executing one or more telecommunications and/or data communications protocols. The instructions may be stored in the form of the computer program 2350. In some examples, the processor or processing circuitry 2302 may include one or more microprocessors or microcontrollers, as well as other digital hardware, which may include digital signal processors (DSPs), special-purpose digital logic, etc. The processor or processing circuitry 2302 may be implemented by any type of integrated circuit, such as an Application Specific Integrated Circuit (ASIC), Field Programmable Gate Array (FPGA) etc. The memory 2304 may include one or several types of memory suitable for the processor, such as read-only memory (ROM), random-access memory, cache memory, flash memory devices, optical storage devices, solid state disk, hard disk drive etc.

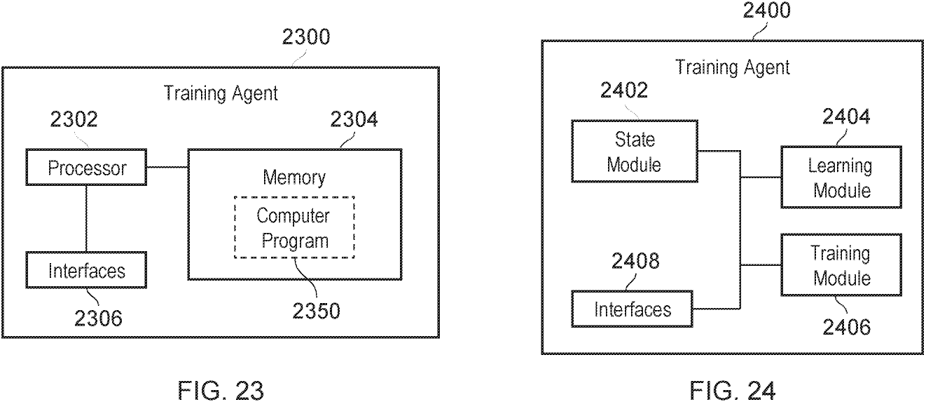

FIG. 24 illustrates functional modules in another example of training agent 2400 which may execute examples of the method 900 of the present disclosure, for example according to computer readable instructions received from a computer program. It will be understood that the modules illustrated in FIG. 16 are functional modules, and may be realised in any appropriate combination of hardware and/or software. The modules may comprise one or more processors and may be integrated to any degree.

Referring to FIG. 24, the training agent 2400 is for training a neural network having a plurality of parameters, wherein the neural network is for selecting a radio resource allocation for a radio resource or user in a communication network. The training agent comprises a state module 2402 for generating a representation of a scheduling state of a simulated cell of the communication network for an allocation episode, wherein the scheduling state representation includes radio resources of the simulated cell that are available for allocation during the allocation episode, users requesting allocation of simulated cell radio resources during the allocation episode, and a current allocation of simulated cell radio resources to users for the allocation episode. The training agent 2400 further comprises a learning module 2404 for performing a series of steps sequentially for each radio resource or for each user in the representation. The steps comprise selecting from the radio resources and users in the scheduling state representation, a radio resource or a user, and performing a look ahead search of possible future scheduling states of the simulated cell according to possible radio resource allocations for the selected radio resource or user, wherein the look ahead search is guided by the neural network in accordance with current values of the neural network parameters and a current version of the scheduling state representation, and wherein the look ahead search outputs a search allocation prediction and a search success prediction. The steps further comprise adding the current version of the scheduling state representation, and the search allocation prediction and search success prediction output by the look ahead search, to a training data set, selecting a resource allocation for the selected radio resource or user in accordance with the search allocation prediction output by the look ahead search, and updating the current scheduling state representation of the simulated cell to include the selected radio resource allocation for the selected radio resource or user. The learning module 2404 may comprise sub modules including a selection module, a search module, a data module, and a resource module. The training agent 2400 further comprises a training module 2406 for using the training data set to update the values of the neural network parameters. The training agent may further comprise interfaces 2408.

Aspects of the present disclosure, as demonstrated by the above discussion, provide a solution for resource scheduling in communication network, which solution may be particularly effective in complex environments including for example Multi User MIMO. The methods proposed in the present disclosure do not require heuristics developed by domain experts, and can be adapted to handle different optimization criteria, including for example maximizing total throughput, or fair scheduling according to which all users are receiving a minimum throughput. When changes in the environment result in reduced performance of the scheduling method, the neural network used in scheduling may be retrained with minimum human support.

Example methods according to the present disclosure use a look ahead search, such as Monte Carlo Tree Search, together with Reinforcement Learning to train a scheduling policy off-line. During online resource allocation, the policy is used “as is” and is not augmented by Monte-Carlo Tree Search, in contrast to the AlphaZero game playing agent. For the purposes of the methods disclosed herein, the look ahead search is used purely as a policy improvement operator during training.

The scheduling method proposed herein can learn to select optimal or close to optimal scheduling decisions without relying on pre-programmed heuristics, so reducing the need for domain expertise. As training is performed off-line, there is no additional impact on the radio network regarding computation and delays for training of the neural network model. Using the neural network model “as is”, and without look ahead search in the live phase, is compatible with the time scales for live resource scheduling. Examples of the present disclosure therefore offer the improved performance achieved by a sequential approach to resource scheduling and trained neural network, while remaining compatible with the time constraints of a live resource scheduling problem. The success measure used to guide the selection process can be customized to consider different goals for a communication network operator. For example the success measure may be defined so as to maximize total throughput for all UEs or to ensure a fair distribution by giving reward for UEs that prioritize a certain minimum throughput being given to all UEs. The QoS Class Identifier (QCI) for 4G LTE or the QoS Flow Identifier (QFI) for 5G can be used as a part of the scheduling state in order to give priority to certain types of traffic.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer implemented method for managing allocation of radio resources to users in a cell of a communication network during an allocation episode, the method comprising:
generating a representation of a scheduling state of the cell for the allocation episode, wherein the scheduling state representation includes radio resources of the cell that are available for allocation during the allocation episode, users requesting allocation of cell radio resources during the allocation episode, and a current allocation of cell radio resources to users for the allocation episode;
generating a radio resource allocation decision for the allocation episode by, sequentially for each radio resource or for each user in the representation:
selecting, from the radio resources and users in the representation, a radio resource or a user;
using a trained neural network to update a partial radio resource allocation decision for the allocation episode on the basis of a current version of the scheduling state representation, such that the partial radio resource allocation decision comprises an allocation for the selected radio resource or user; and
updating the scheduling state representation to include the updated partial radio resource allocation decision;
the method further comprising:
initiating allocation of cell radio resources to users during the allocation episode in accordance with the generated radio resource allocation decision.

2. The computer implemented method of claim 1, wherein the scheduling state representation further includes:
a channel state measure for each user requesting allocation of cell radio resources during the allocation episode, and for radio resource of the cell that is available for allocation during the allocation episode.

3. The computer implemented method of claim 1, wherein the scheduling state representation further includes:
a buffer state measure for each user requesting allocation of cell radio resources during the allocation episode.

4. The computer implemented method of claim 1, wherein the scheduling state representation further includes:
a channel direction of each user requesting allocation of cell radio resources during the allocation episode and radio resource of the cell that is available for allocation during the allocation episode.

5. The computer implemented method of claim 1, wherein the scheduling state representation further includes:
a complex channel matrix of each user requesting allocation of cell radio resources during the allocation episode and radio resource of the cell that is available for allocation during the allocation episode.

6. The computer implemented method of claim 1, wherein using a trained neural network to update a partial radio resource allocation decision for the allocation episode on the basis of a current version of the scheduling state representation, such that the partial radio resource allocation decision comprising an allocation for the selected radio resource or user, comprises:
inputting a current version of the scheduling state representation to the trained neural network, wherein the neural network processes the current version of the scheduling state representation in accordance with parameters of the neural network that have been set during training, and outputs a neural network allocation prediction;
selecting a radio resource allocation for the selected radio resource or user based on the neural network allocation prediction output by the neural network; and
updating a current version of the partial radio resource allocation decision to include the selected radio resource allocation for the selected radio resource or user.

7. The computer implemented method of claim 6, wherein:
the neural network allocation prediction comprises an allocation prediction vector, each element of the allocation prediction vector corresponding to a possible radio resource allocation for the selected radio resource or user and comprising a probability that the corresponding radio resource allocation is the most favorable of the possible radio resource allocations according to a success measure; and wherein:
updating a partial radio resource allocation decision for the allocation episode based on the neural network allocation prediction comprises selecting the radio resource allocation for the selected radio resource or user corresponding to the highest probability in the allocation prediction vector.

8. The computer implemented method of claim 5, wherein the neural network further outputs a neural network success prediction comprising a predicted value of the success measure for the current scheduling state of the cell.

9. The computer implemented method of claim 6, wherein the success measure comprises a representation of at least one performance parameter for the cell during the allocation episode.

10. The computer implemented method of claim 9, wherein the success measure comprises a combined representation of a plurality of performance parameters for the cell over the allocation episode.

11. The computer implemented method of claim 10, wherein at least one of the performance parameters comprises a user specific performance parameter.

12. The computer implemented method of claim 6, further comprising:
selecting a success measure for radio resource allocation for the allocation episode.

13. (canceled)

14. A computer implemented method for training a neural network having a plurality of parameters, wherein the neural network is for selecting a radio resource allocation for a radio resource or user in a communication network, the method comprising:
generating a representation of a scheduling state of a simulated cell of the communication network for an allocation episode, wherein the scheduling state representation includes radio resources of the simulated cell that are available for allocation during the allocation episode, users requesting allocation of simulated cell radio resources during the allocation episode, and a current allocation of simulated cell radio resources to users for the allocation episode; and sequentially for each radio resource or for each user in the representation:
selecting from the radio resources and users in the scheduling state representation, a radio resource or a user;
performing a look ahead search of possible future scheduling states of the simulated cell according to possible radio resource allocations for the selected radio resource or user, wherein the look ahead search is guided by the neural network in accordance with current values of the neural network parameters and a current version of the scheduling state representation, and wherein the look ahead search outputs a search allocation prediction and a search success prediction;
adding the current version of the scheduling state representation, and the search allocation prediction and search success prediction output by the look ahead search, to a training data set;
selecting a resource allocation for the selected radio resource or user in accordance with the search allocation prediction output by the look ahead search; and
updating the current scheduling state representation of the simulated cell to include the selected radio resource allocation for the selected radio resource or user;
the method further comprising:
using the training data set to update the values of the neural network parameters .

15. The computer implemented method of claim 14, wherein the search success prediction comprises a predicted value of a success measure for the current scheduling state of the simulated cell.

16. The computer implemented method of claim 14, wherein the search allocation prediction comprises an allocation prediction vector, each element of the allocation prediction vector corresponding to a possible radio resource allocation for the selected radio resource or user, and comprising a probability that the corresponding radio resource allocation is the most favorable of the possible radio resource allocations according to the success measure.

17. The computer implemented method of claim 14, wherein the neural network is configured to receive an input comprising the current version of the scheduling state representation of the simulated cell, to process the input scheduling state representation in accordance with current values of the neural network parameters, and to output a neural network allocation prediction.

18. The computer implemented method of claim 17, wherein the neural network allocation prediction comprises an allocation prediction vector, each element of the allocation prediction vector corresponding to a possible radio resource allocation for the selected radio resource or user, and comprising a probability that the corresponding radio resource allocation is the most favorable of the possible radio resource allocations according to the success measure.

19. The computer implemented method of claim 17, wherein the neural network is further configured to output a neural network success prediction comprising a predicted value of the success measure for the current scheduling state of the cell.

20-33. (canceled)

34. A scheduling node for managing allocation of radio resources to users in a cell of a communication network during an allocation episode, the scheduling node comprising processing circuitry configured to:
generate a representation of a scheduling state of the cell for the allocation episode, wherein the scheduling state representation includes radio resources of the cell that are available for allocation during the allocation episode, users requesting allocation of cell radio resources during the allocation episode, and a current allocation of cell radio resources to users for the allocation episode;
generate a radio resource allocation decision for the allocation episode by, sequentially for each radio resource or for each user in the representation:
selecting, from the radio resources and users in the representation, a radio resource or a user;
using a trained neural network to update a partial radio resource allocation decision for the allocation episode on the basis of a current version of the scheduling state representation, such that the partial radio resource allocation decision comprises an allocation for the selected radio resource or user; and
updating the scheduling state representation to include the updated partial radio resource allocation decision;
the processing circuitry further configured to:
initiate allocation of cell radio resources to users during the allocation episode in accordance with the generated radio resource allocation decision.

35. (canceled)

36. A training agent for training a neural network having a plurality of parameters, wherein the neural network is for selecting a radio resource allocation decision for a radio resource or user in a communication network, the training node comprising processing circuitry configured to:
generate a representation of a scheduling state of a simulated cell of the communication network for an allocation episode, wherein the scheduling state representation includes radio resources of the simulated cell that are available for allocation during the allocation episode, users requesting allocation of simulated cell radio resources during the allocation episode, and a current allocation of simulated cell radio resources to users for the allocation episode; and sequentially for each radio resource or for each user in the representation:
select from the radio resources and users in the scheduling state representation, a radio resource or a user;
perform a look ahead search of possible future scheduling states of the simulated cell according to possible radio resource allocations for the selected radio resource or user, wherein the look ahead search is guided by the neural network in accordance with current values of the neural network parameters and a current version of the scheduling state representation, and wherein the look ahead search outputs a search allocation prediction and a search success prediction;
add the current version of the scheduling state representation, and the search allocation prediction and search success prediction output by the look ahead search, to a training data set; select a resource allocation for the selected radio resource or user in accordance with the search allocation prediction output by the look ahead search; and
update the current scheduling state representation of the simulated cell to include the selected radio resource allocation for the selected radio resource or user;
the processing circuitry further configured to:
use the training data set to update the values of the neural network parameters.

37. (canceled)
